(19) United States
(12) Patent Application Publication
(10) Pub. No.: US 2025/0196165 A1
(43) Pub. Date: Jun. 19, 2025

(54) WATER OUTLET DEVICE AND FLOW REGULATING AND OPENING-CLOSING STRUCTURE THEREOF

(71) Applicant: Changkun CHI, Longyan (CN)

(72) Inventor: Changkun CHI, Longyan (CN)

(21) Appl. No.: 18/979,385

(22) Filed: Dec. 12, 2024

(30) Foreign Application Priority Data
Dec. 13, 2023 (CN) 2023234012317
Mar. 6, 2024 (CN) 2024204331337

(51) Int. Cl. B05B 1/30

(52) U.S. Cl. CPC B05B 1/3026; B05B 1/3013

(57) ABSTRACT

The disclosure provides a water outlet device and a flow regulating and opening-closing structure thereof, wherein only one switch can realize two functions of opening and closing a water pipeline and flow regulating, and the two functions do not interfere with each other, so as to satisfy the user's requirement of not changing after setting the flow. The flow regulating and opening-closing structure includes a water passing body and a control shaft; a movable hole is in communication between opposite sides of the water passing body; the two sides of the movable hole are respectively provided with a water inlet hole and a water outlet hole; the control shaft is movably and sealingly fitted in the movable hole, and axially moves and rotates relative to the movable hole; the peripheral surface of the control shaft is provided with a notch for passing water.

### CROSS-REFERENCE TO RELATED APPLICATIONS

The application claims priority to Chinese patent application No. 2023234012317, filed on Dec. 13, 2023, and No. 2024204331337 filed on Mar. 6, 2024, the entire contents of which are incorporated herein by reference.

### TECHNICAL FIELD

The disclosure relates to the technical field of bathroom products and particularly relates to a water outlet device and a flow regulating and opening-closing structure thereof.

### BACKGROUND

The hand-held shower head and spray gun are a branch form of the faucet, which is more suitable for use with human hands, and the water inlet end thereof is usually connected to the water supply pipeline in the room via a hose, and a knob is provided on the shower head/spray gun body, and the knob can realize the switch for controlling the water pipeline and the flow regulating. That is to say, the existing shower head/spray gun generally achieves two functions of opening and closing the water pipeline and regulating the flow at the same time by means of a knob, and the principle thereof is that when the knob rotates, the water passing section of the water pipeline can be changed, and when the water passing section is zero, the spray gun does not discharge water, and as the knob rotates, the water passing section gradually increases, and the flow of the spray gun increases. This results in that each time the user wants to use the spray gun, the flow of the spray gun needs to be readjusted. For some single-use and constant application scenarios of shower head/spray gun, the user would prefer that the flow of the spray gun does not change after one adjustment, and the spray gun can be directly used by opening the water pipeline.

In response to the above-mentioned problems, the solution in the industry is generally to design two switches to respectively control the opening and closing of the water pipeline and the flow regulation, but the accessories of the product will be increased, the installation difficulty and the cost will become higher.

### SUMMARY

The purpose of the disclosure is to provide a water outlet device and a flow regulating and opening-closing structure thereof and solve the problems existing in the prior art, wherein only one switch can realize two functions of water pipeline opening-closing and flow regulating, and the two functions do not interfere with each other, so as to satisfy the user's requirement of not changing after setting the flow.

In order to achieve the above object, one of the solutions of the disclosure is:
a flow regulating and opening-closing structure including a water passing body and a control shaft; a movable hole communicated between opposite sides of the water passing body; two sides of the movable hole respectively provided with a water inlet hole and a water outlet hole; the control shaft being movably and sealingly fitted in the movable hole, and axially moving and rotating relative to the movable hole; the peripheral surface of the control shaft being provided with a notch for passing water, and the notch making the water inlet hole and the water outlet hole in communication with or not in communication with each other along with the axial movement of the control shaft in the movable hole; when the notch making the water inlet hole in communication with the water outlet hole, the water passing section between the water inlet hole and the water outlet hole changes as the control shaft rotates in the movable hole.

The water inlet hole and the water outlet hole are provided in a misplaced manner in the axial direction of the movable hole, and the height of the notch is not less than the distance between the water inlet hole and the water outlet hole in the axial direction of the movable hole; the opening degree of the notch is such that when the water inlet hole and the water outlet hole are in communication, both can be in a maximum flow state at the same time.

A rib is connected between the upper and lower walls of the notch.

Several sealing rings are provided on a peripheral surface of the control shaft, and the sealing rings are movably and sealingly fitted on a side wall of the movable hole along with the axial movement of the control shaft.

The control shaft includes a shaft body and an end head which are detachably connected; the notch is formed in a peripheral surface of the shaft body.

Preferably, the side wall of the movable hole is provided with a limiting protrusion, and the peripheral surface of the end head is provided with a limiting groove for the limiting protrusion to movably fit; the limiting protrusion is movably fitted between both ends of the limiting groove along with the rotation of the control shaft, for limiting the rotation angle of the control shaft.

Preferably, a direction mark is provided on an end face of the shaft body or the end head.

The second solution of the disclosure is:
a water outlet device including the flow regulating and opening-closing structure.

The water passing body includes a housing and a water inlet pipe; a water outlet cavity is provided in the housing, and the water outlet cavity is provided with several water spraying holes; the water inlet pipe is inserted into the housing and is in communication with the water outlet cavity; the movable hole is provided on an end peripheral surface of the water inlet pipe in communication with the water outlet cavity, and penetrates to a surface of the housing.

With the above technical solution, the disclosure has the following technical effects:
the disclosure designs a notch on the control shaft, wherein the notch can simultaneously be in communication with the water inlet hole and the water outlet hole of the movable hole, and realizes the function of opening and closing the water pipeline with the axial movement of the control shaft, and at the same time realizes the function of flow regulating by the rotation of the control shaft, and the two functions do not interfere with each other; a user can realize the functions of opening and closing the water pipeline and flow regulating respectively by only moving and not rotating the control shaft or only rotating and not moving the control shaft, so as to realize that the user can adjust the magnitude of the flow both during the opening and closing of the spray gun, and at the same time, when the state of switching the water on and off is switched, the flow regulating position will not be changed, and the flow is constant to meet the user's requirements.

### BRIEF DESCRIPTION OF DRAWINGS

FIG. 1 is a perspective view of a first embodiment of the disclosure;

FIG. 2 is an exploded view of a first embodiment of the disclosure;

FIG. 3 is a front view of the maximum flow state during the opening of the first embodiment of the disclosure;

FIG. 4 is a cross-sectional view taken along the direction A-A in FIG. 3;

FIG. 5 is a cross-sectional view taken along the direction B-B in FIG. 4;

FIG. 6 is a cross-sectional view of the minimum flow state during the opening of the first embodiment of the disclosure (direction B-B in FIG. 4);

FIG. 7 is a schematic diagram of a closed water outlet state of the first embodiment of the disclosure;

FIG. 8 is a schematic diagram of a first embodiment of the disclosure fitted with a shower head;

FIG. 9 is a perspective view of a second embodiment of the disclosure;

FIG. 10 is a front view of a maximum flow state during the opening of a second embodiment of the disclosure;

FIG. 11 is a cross-sectional view taken along the direction C-C in FIG. 10;

FIG. 12 is a cross-sectional view taken along the direction D-D in FIG. 11;

FIG. 13 is a cross-sectional view taken along the direction E-E in FIG. 11;

FIG. 14 is a front view of a minimum flow state during the opening of the second embodiment of the disclosure;

FIG. 15 is a cross-sectional view taken along the direction F-F in FIG. 14;

FIG. 16 is a cross-sectional view taken along the direction G-G in FIG. 14; and

FIG. 17 is a schematic diagram of a closed water outlet state of a second embodiment of the disclosure;

### DESCRIPTION OF REFERENCE NUMERALS

1—water passing body; 1a—housing; 1b—water inlet pipe; 11—movable hole; 12—water inlet hole; 13—water outlet hole; 14—limiting protrusion; 15—joint; 16—interface; 17—water outlet cavity; 171—water spraying holes; 172—convex pipe; 18—inverted buckle;
2—control shaft; 2a—shaft body; 2b—end head; 21—notch; 22—rib; 23—limiting groove; 24—direction mark;
3—sealing rings; 3a—first sealing ring; 3b—second sealing ring; 3c—third sealing ring; 3d—fourth sealing ring; 3e—fifth sealing ring;
4—shower head.

### DETAILED DESCRIPTION OF THE EMBODIMENTS

In order to further explain the technical solution of the disclosure, the disclosure is described in detail below through specific embodiments.

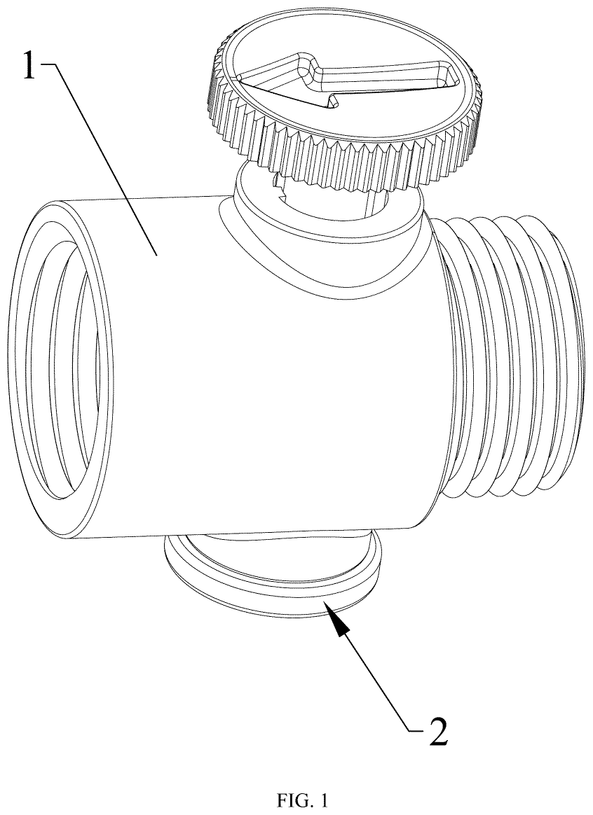

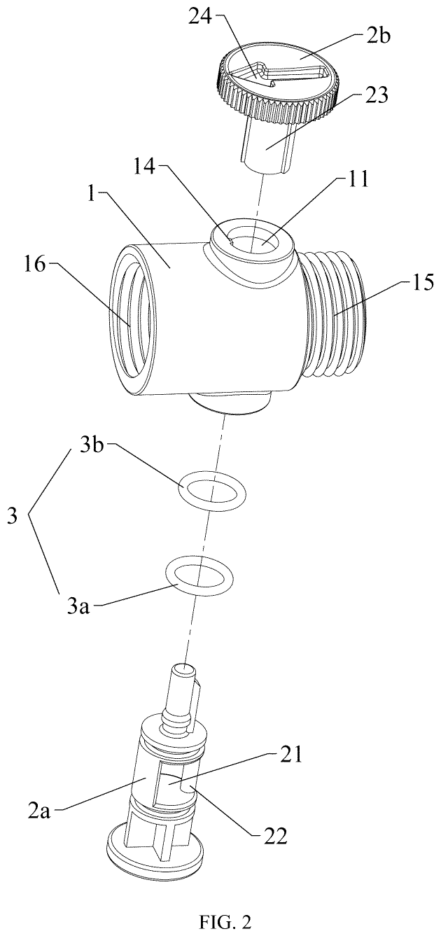

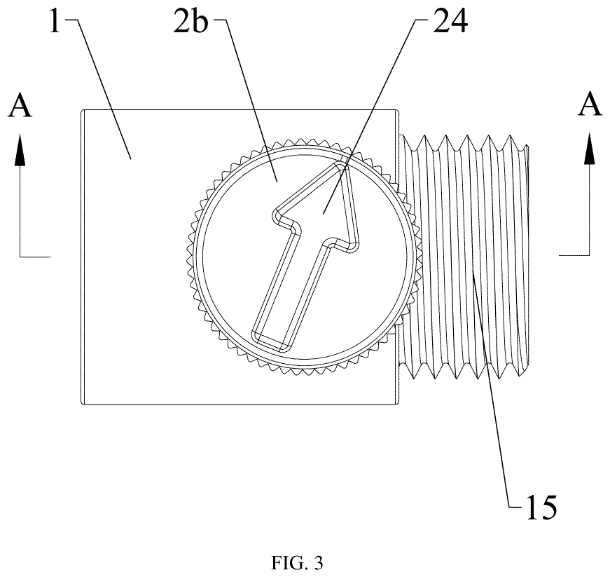

With reference to FIG. 1 to FIG. 9, the disclosure discloses a flow regulating and opening-closing structure, including a water passing body 1 and a control shaft 2;

A movable hole 11 is in communication between opposite side surfaces of the water passing body 1; the two sides of the movable hole 11 are respectively provided with a water inlet hole 12 and a water outlet hole 13 so as to be in communication with the water inlet end and the water outlet end of the water passing body 1;

The control shaft 2 is movably and sealingly fitted in the movable hole 11, and axially moves and rotates relative to the movable hole 11; the peripheral surface of the control shaft 2 is provided with a notch 21 for passing water, and notch 21 enables the water inlet hole 12 to in communication with or not in communication with the water outlet hole 13 with the axial movement of the control shaft 2 in the movable hole 11, that is to say when the notch 21 is opposite to the water inlet hole 12 and the water outlet hole 13 at the same time, the two holes are communicated, and when the notch 21 is opposite to only one of the holes, the two holes are not communicated; when the notch 21 makes the water inlet hole 12 and the water outlet hole 13 in communication with each other, the water passing section between the water inlet hole 12 and the water outlet hole 13 changes as the control shaft 2 rotates in the movable hole 11.

By means of the above-mentioned solution, the disclosure designs a notch 21 on the control shaft 2, wherein the notch 21 can simultaneously in communication with the water inlet hole 12 and the water outlet hole 13 of the movable hole 11, and realizes the function of opening and closing a water pipeline along with the axial movement of the control shaft 2, and at the same time realizes the function of flow regulating by the rotation of the control shaft 2; there is no mutual interference between the two functions, and a user can respectively achieve the functions of opening and closing a water pipeline and adjusting the flow by only moving and not rotating the control shaft 2 or only rotating and not moving the control shaft 2, so that the user can adjust the flow during the opening or closing of the spray gun; at the same time, the position of flow regulation will not be changed when the state of switch water is switched, and the flow is constant to meet the user's requirements.

In some embodiments of the disclosure, the above-mentioned water inlet hole 12 and water outlet hole 13 are provided in a misplaced manner in the axial direction of the movable hole 11, the height of the notch 21 is not less than the distance between the water inlet hole 12 and the water outlet hole 13 in the axial direction of the movable hole 11, so as to ensure that the water outlet hole 13 can also communicate to the notch 21 when the notch 21 completely overlaps the water inlet hole 12 in the axial direction (in a completely opened state), thereby achieving the communication between the water inlet hole 12 and the water outlet hole 13; at the same time, the opening degree of the notch 21 is such that when the water inlet hole 12 and the water outlet hole 13 in communication with each other, both of them can be in a maximum flow state at the same time, namely, the water passing section is the largest.

In some embodiments of the disclosure, a rib 22 is connected between the upper and lower walls of the above-mentioned notch 21, and the rib 22 can improve the strength of the control shaft 2 as a whole, especially when the opening degree of the notch 21 is large, it can ensure that the force of the control shaft 2 is not concentrated on the side wall of the notch 21 and the control shaft 2 is prevented from breaking.

In some embodiments of the disclosure, several sealing rings 3 are provided on the peripheral surface of the above-mentioned control shaft 2, and the sealing rings 3 are movably and sealingly fitted on the side wall of the movable hole 11 along with the axial movement of the control shaft 2, for preventing water leakage.

In some embodiments of the disclosure, in order to facilitate assembly, the above-mentioned control shaft 2 includes a shaft body 2a and an end head 2b which are detachably connected; the above-mentioned notch 21 is formed on the peripheral surface of the shaft body 2a, specifically, the shaft body 2a is provided with a cylindrical body fitted with the movable hole 11, the notch 21 is formed on the peripheral surface of the cylindrical body, the cylindrical body passes through the movable hole 11 and is in a snap connection with the end head 2b, the end head 2b can prevent the cylindrical body from falling out of the movable hole 11, and can cooperate with the shaft body 2a so as to limit the stroke of the whole control shaft 2 to move axially, and two ends of the stroke can be designed to respectively correspond to the open and closed positions of the product, so that a user can directly press the control shaft 2 to a position which cannot move axially again so as to achieve opening; fast switching of off position.

Further, the side wall of the above-mentioned movable hole 11 is provided with a limiting protrusion 14, and the peripheral surface of the end head 2b is provided with a limiting groove 23 for the limiting protrusion 14 to movably fit; the limiting protrusion 14 is movably fitted between the two ends of the limiting groove 23 along with the rotation of the control shaft 2, and is used for limiting the rotation angle of the control shaft 2. When designing a product, the positions of the limiting protrusion 14 at the two ends of the limiting groove 23 can respectively correspond to the minimum flow and maximum flow positions of the product.

Meanwhile, a direction mark 24 for indicating the angular state of the control shaft 2 is provided on the end face of the shaft body 2a or the end head 2b.

With reference to FIG. 1 to FIG. 8, a first embodiment of the disclosure is shown.

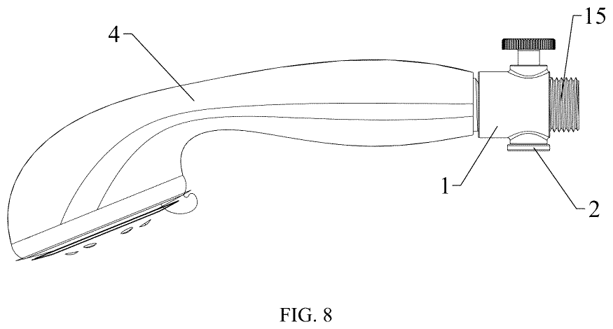

In the first embodiment, both ends of the above-mentioned water passing body 1 are respectively provided with a joint 15 having an external thread and an interface 16 having an internal thread, and the water inlet hole 12 is communicated to the joint 15 and the water outlet hole 13 is communicated to the interface 16. Then, the flow regulating and opening-closing structure in the first embodiment can be a fitting capable of controlling the flow, and with reference to FIG. 8, the interface 16 thereof can be assembled with the water inlet end of the water outlet device such as the shower head 4, and the joint 15 can be connected to a water pipe.

In the first embodiment, the above-mentioned axial movement of the control shaft 2 changes the relative state of the notch 21 and the water outlet hole 13, and the notch 21 is always in communication with the water inlet hole 12; the sealing ring 3 includes a first sealing ring 3a and a second sealing ring 3b, wherein the first sealing ring 3a is always movably fitted on an axial side of the water inlet hole 12 away from the water outlet hole 13, and the second sealing ring 3b is movably fitted on two axial sides of the water outlet hole 13.

The working principle of the first embodiment is as follows.

### (1) Maximum Flow State:

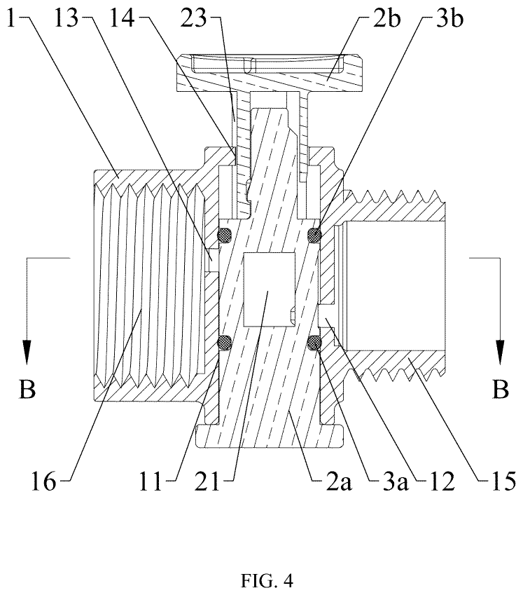

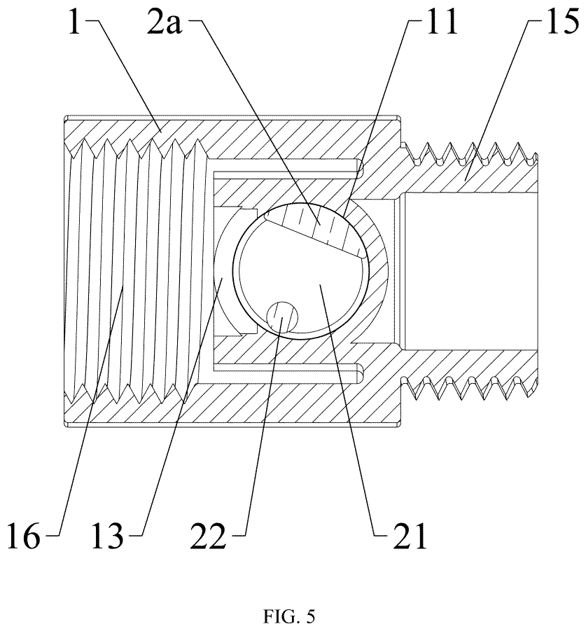

the water inlet hole 12 is always in communication with the notch 21; with reference to FIG. 4 and FIG. 5, when the control shaft 2 is in the maximum flow position, the notch 21 and the water outlet hole 13 completely overlap in the axial direction, and at this time, the control shaft 2 is rotated so that the notch 21 of the control shaft 2 is opposite to the water outlet hole 13, and at this time, the water outlet hole 13 is no longer blocked, the flow is maximum, and the water flow enters directly from the joint 15 and flows through the water inlet hole 12, the notch 21 and the water outlet hole 13 and flows out of the interface 16.

### (2) Minimum Flow State:

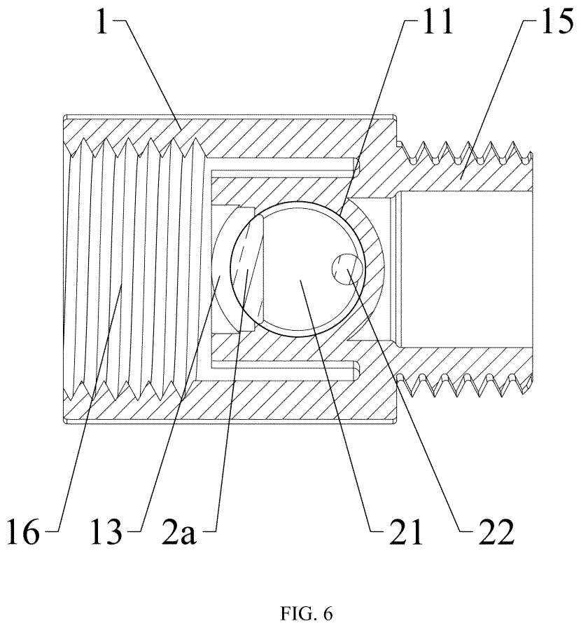

with reference to FIG. 6, when the control shaft 2 is in a minimum flow position, the notch 21 of the control shaft 2 faces away from the water outlet hole 13, and at this time, the water outlet hole 13 is completely blocked by the control shaft 2 (namely, the side wall of the notch 21), and the flow is minimum; and after the water flows into the water inlet hole 12, the water can only enter the water outlet hole 13 via the gap between the control shaft 2 and the movable hole 11.

### (3) Water Outlet Closing State:

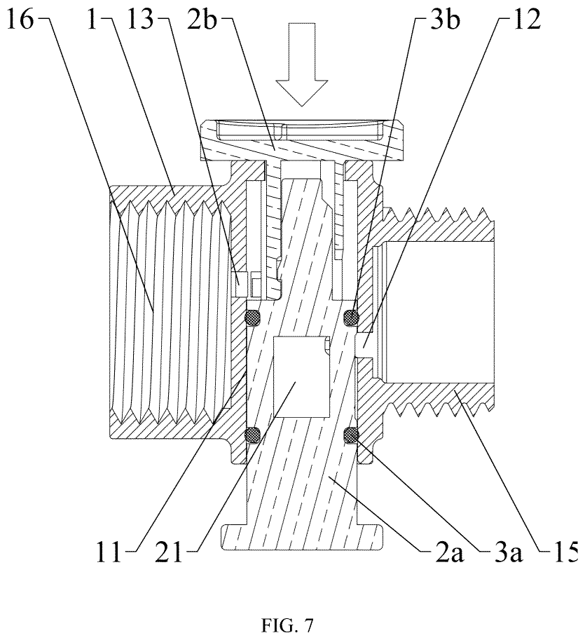

with reference to FIG. 7, when the user presses the control shaft 2 to move it axially, the notch 21 is completely misplaced from the water outlet hole 13 in the axial direction, and the two axial sides of the water inlet hole 12 are respectively sealed by the first sealing ring 3a and the second sealing ring 3b, and the product no longer flows out of the water.

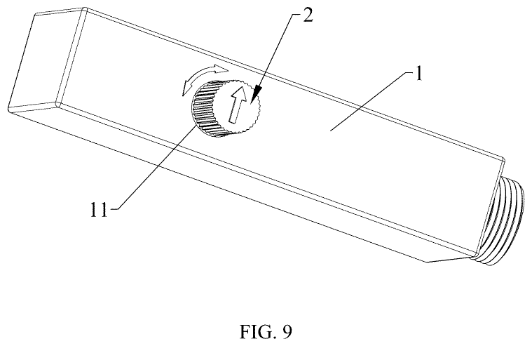

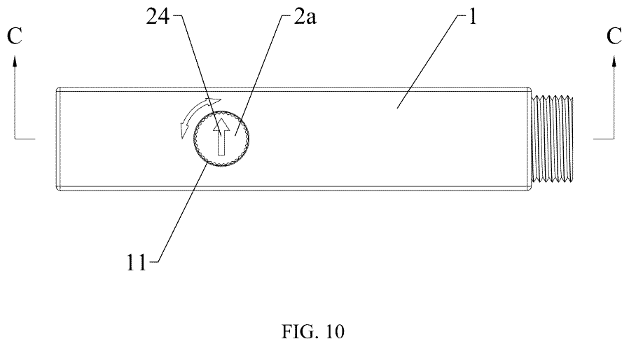

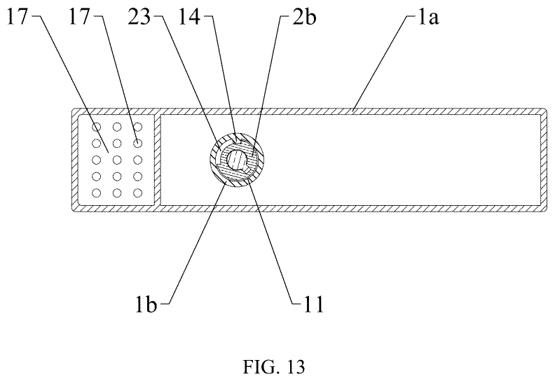

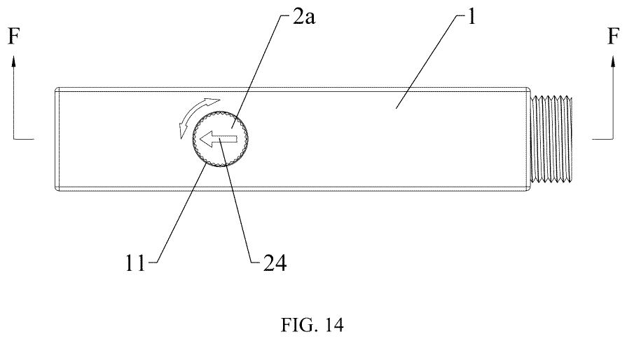

With reference to FIG. 9 to FIG. 17, a second embodiment of the disclosure is shown.

In the second embodiment, the above-mentioned water passing body 1 is a spray gun body, i.e. the flow regulating and opening-closing structure can be directly applied to a water outlet device such as a shower head, a top spray, and a spray gun. In the second embodiment, the above-mentioned water passing body 1 includes a housing 1a and a water inlet pipe 1b; a water outlet cavity 17 is provided in the housing 1a, and the water outlet cavity 17 is provided with several water spraying holes 171; the water inlet pipe 1b is inserted into the housing 1a, and is in communication with the water outlet cavity 17; the movable hole 11 is provided on the peripheral surface of the end of the water inlet pipe 1b in communication with the water outlet cavity 17, and penetrates to the surface of the housing 1a. In this embodiment, the water inlet pipe 1b is provided with a tubular structure for forming the movable hole 11.

Further, the outer wall of the above-mentioned water outlet cavity 17 is provided with a convex pipe 172; one end of the water inlet pipe 1b is sealingly sheathed on the convex pipe 172 so as to achieve in communication with the water outlet cavity 17; the other end of the water inlet pipe 1b is provided with at least one inverted buckle 18 on the inner side of the housing 1a, and the inverted buckle 18 is hooked on the inner wall of the housing 1a so as to prevent the water inlet pipe 1b from falling out of the housing 1a. In the present embodiment, the other end of the water inlet pipe 1b is provided with a threaded joint on the outer side of the housing 1a to facilitate the connection of a hose, a water pipe, or the like.

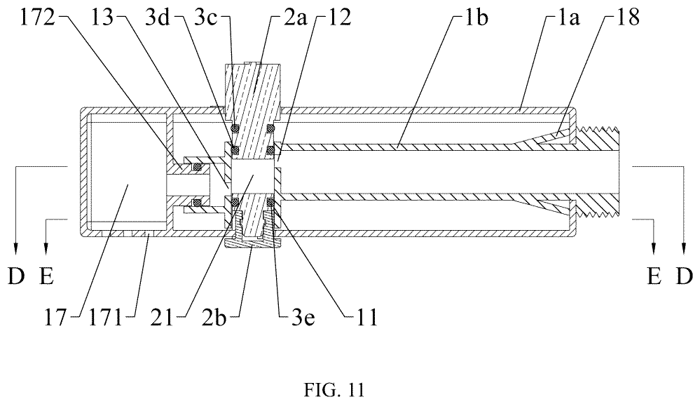

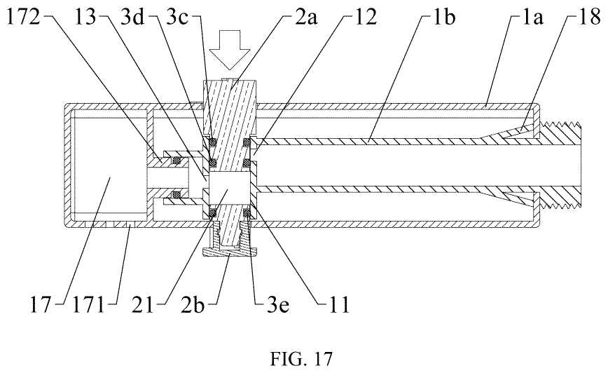

In the second embodiment, the above-mentioned axial movement of the control shaft 2 changes the relative state of the notch 21 and the water inlet hole 12, and the notch 21 is always in communication with the water outlet hole 13; the sealing ring 3 includes a third sealing ring 3c, a fourth sealing ring 3d and a fifth sealing ring 3e; the third sealing ring 3c is always movably fitted on the side of the water inlet hole 12 away from the water outlet hole 13, the fourth sealing ring 3d is always movably fitted on both sides of the water inlet hole 12, and the fifth sealing ring 3e is always movably fitted on the side of the water outlet hole 13 away from the water inlet hole 12, when the control shaft 2 is in an open position (see FIG. 11), sealing the movable hole 11 by the fourth sealing ring 3d and the fifth sealing ring 3e to prevent water leakage; when the control shaft 2 is in the closed position (see FIG. 17), the first sealing ring 2 and the second sealing ring 3 seal the movable hole 11 (namely, the water inlet hole 12) to prevent water leakage.

The working principle of the second embodiment is as follows.

### (1) Maximum Flow State:

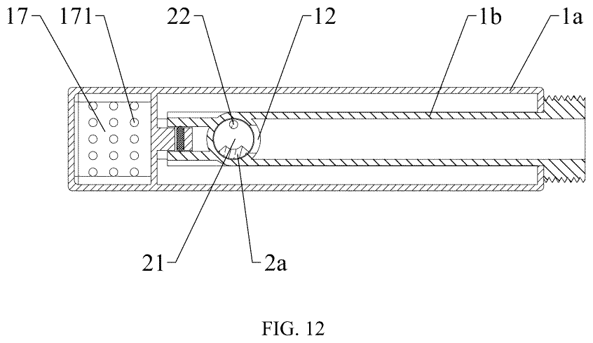

The water outlet hole 13 is always in communication with the notch 21; with reference to FIG. 11 and FIG. 12, when the control shaft 2 is in the maximum flow open position, the notch 21 completely overlaps with the water inlet hole 12 in the axial direction, and at this time, the control shaft 2 is rotated so that the notch 21 of the control shaft 2 is opposite to the water inlet hole 12, and at this time, the water inlet hole 12 is no longer blocked, and the flow is maximum, and the water flow enters directly from the water inlet pipe 1b and flows through the notch 21 into the water passing cavity 14 of the housing 1a, and is finally ejected from the water spraying holes 171.

### (2) Minimum Flow State:

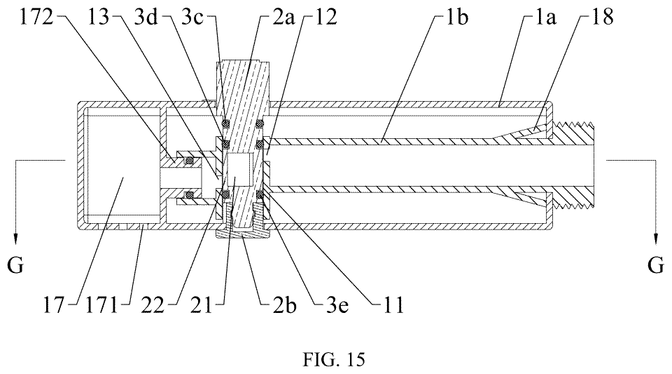

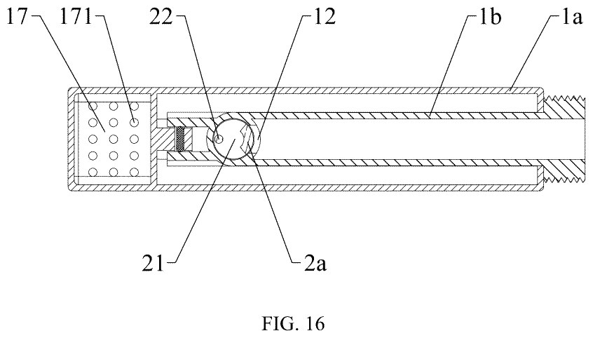

With reference to FIG. 15 and FIG. 16, when the control shaft 2 is in the minimum flow position, the notch 21 of the control shaft 2 faces away from the water inlet hole 12, and at this time, the water inlet hole 12 is completely blocked by the control shaft 2, the flow is minimum, and after the water enters the water inlet pipe 1b, the water can only enter the water outlet hole 13 via the gap between the control shaft 2 and the movable hole 11.

### (3) Water Outlet Closing State:

When the user presses the control shaft 2 to move it axially, the notch 21 is completely misplaced with the water inlet hole 12 in the axial direction, and both axial sides of the water inlet hole 12 are respectively sealed by the third sealing ring 3c and the fourth sealing ring 3d, and the product no longer flows out of the water.

The above-mentioned embodiments and figures do not limit the product form and style of the disclosure, and any appropriate changes or modifications made thereto by a person of ordinary skill in the art should be considered as not departing from the scope of the patent of the disclosure.

What is claimed is:

1. A flow regulating and opening-closing structure,
comprising a water passing body and a control shaft;
a movable hole communicated between opposite sides of the water passing body; two sides of the movable hole respectively provided with a water inlet hole and a water outlet hole;
the control shaft being movably and sealingly fitted in the movable hole, and axially moving and rotating relative to the movable hole; a peripheral surface of the control shaft being provided with a notch for passing water, and the notch making the water inlet hole and the water outlet hole in communication with or not in communication with each other along with the axial movement of the control shaft in the movable hole; when the notch making the water inlet hole in communication with the water outlet hole, the water passing section between the water inlet hole and the water outlet hole changes as the control shaft rotates in the movable hole.

2. The flow regulating and opening-closing structure according to claim 1, wherein
the water inlet hole and the water outlet hole are provided in a misplaced manner in the axial direction of the movable hole, and the height of the notch is not less than the distance between the water inlet hole and the water outlet hole in the axial direction of the movable hole; the opening degree of the notch allows the water inlet hole and the water outlet hole in a maximum flow state at the same time when the water inlet hole and the water outlet hole are in communication.

3. The flow regulating and opening-closing structure according to claim 1, wherein
a rib is connected between the upper and lower walls of the notch.

4. The flow regulating and opening-closing structure according to claim 1, wherein
several sealing rings are provided on the peripheral surface of the control shaft, and the sealing rings are movably and sealingly fitted on a side wall of the movable hole along with the axial movement of the control shaft.

5. The flow regulating and opening-closing structure according to claim 1, wherein
the control shaft comprises a shaft body and an end head which are detachably connected; the notch is formed in a peripheral surface of the shaft body.

6. The flow regulating and opening-closing structure according to claim 5, wherein
the side wall of the movable hole is provided with a limiting protrusion, and a peripheral surface of the end head is provided with a limiting groove for the limiting protrusion to movably fit; the limiting protrusion is movably fitted between both ends of the limiting groove along with the rotation of the control shaft, for limiting the rotation angle of the control shaft.

7. The flow regulating and opening-closing structure according to claim 5, wherein
a direction mark is provided on an end face of the shaft body or the end head.

8. A water outlet device, comprising the flow regulating and opening-closing structure according to claim 1.

9. The water outlet device according to claim 8, wherein
the water passing body comprises a housing and a water inlet pipe; a water outlet cavity is provided in the housing, and the water outlet cavity is provided with several water spraying holes; the water inlet pipe is inserted into the housing and is in communication with the water outlet cavity; the movable hole is provided on an end peripheral surface of the water inlet pipe in communication with the water outlet cavity, and penetrates to a surface of the housing.
